(19) United States
(12) Patent Application Publication
(10) Pub. No.: US 2012/0146923 A1
(43) Pub. Date: Jun. 14, 2012

(54) TOUCH SCREEN DEVICE

(76) Inventor: Mossab O. Basir, Waterloo (CA)

(21) Appl. No.: 13/269,544

(22) Filed: Oct. 7, 2011

Related U.S. Application Data
(60) Provisional application No. 61/390,672, filed on Oct. 7, 2010.

(51) Int. Cl. G06F 3/041

(52) U.S. Cl. 345/173

(57) ABSTRACT

A touchscreen device allows a user to annotate and grab clips from a variety of materials, such as books and webpages. The clips are annotated with the original source information.

This application claims priority to U.S. Provisional Application Ser. No. 61/390,672, filed Oct. 7, 2010.

### BACKGROUND

There are many different ebook readers, tablets and other touchscreen devices that are good for reading electronic books, web pages, etc, but they are not directed primarily toward reading the books, not note-taking and annotating and the other needs of a typical student.

### SUMMARY

The disclosed touchscreen device allows users to take the static, Dimensional world of print to the next dimension—allowing readers to interact and consume print publications and 2D media in a smarter, greener and more personal way.

This and other features are disclosed in more detail in the drawings and detailed description below.

### BRIEF DESCRIPTION OF THE DRAWINGS

FIG. 1 is perspective view of a touchscreen device 110 according to one embodiment of the present invention.

FIG. 2 shows a sample of a book note-taking screen for the device of FIG. 1.

FIG. 3 shows a sample of a first web note-taking screen for the device of FIG. 1.

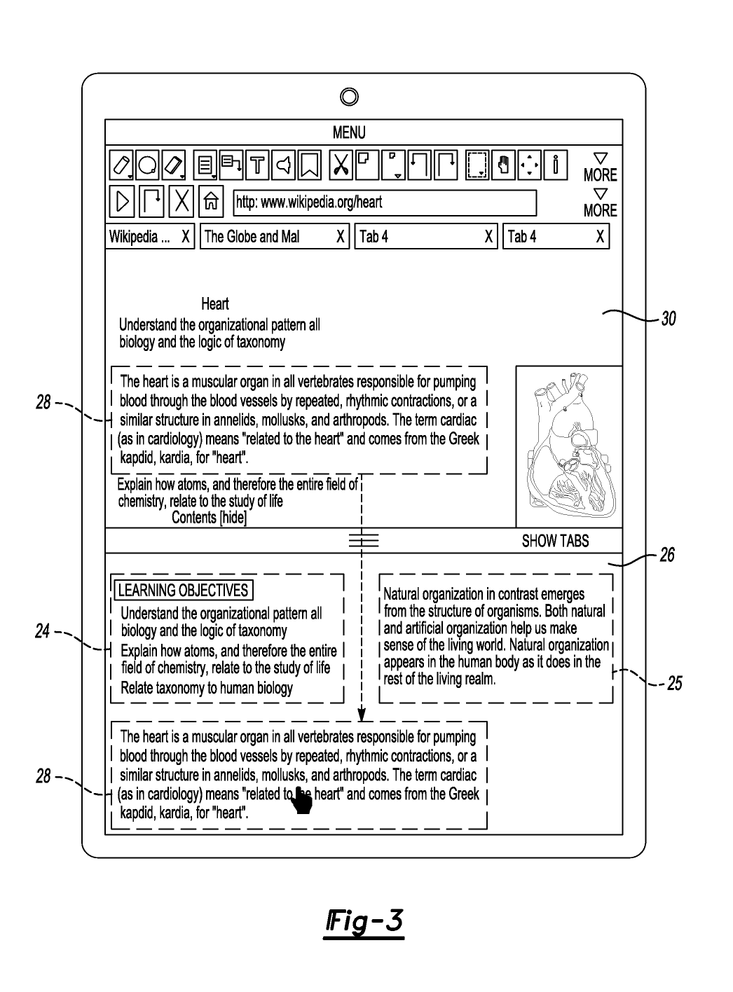

FIG. 4 shows a sample of a second web note-taking screen for the device of FIG. 1.

FIG. 5 shows a sample of a note screen for the device of FIG. 1.

FIG. 6 shows a sample of a campus system incorporating the device of FIG. 1,

### DETAILED DESCRIPTION

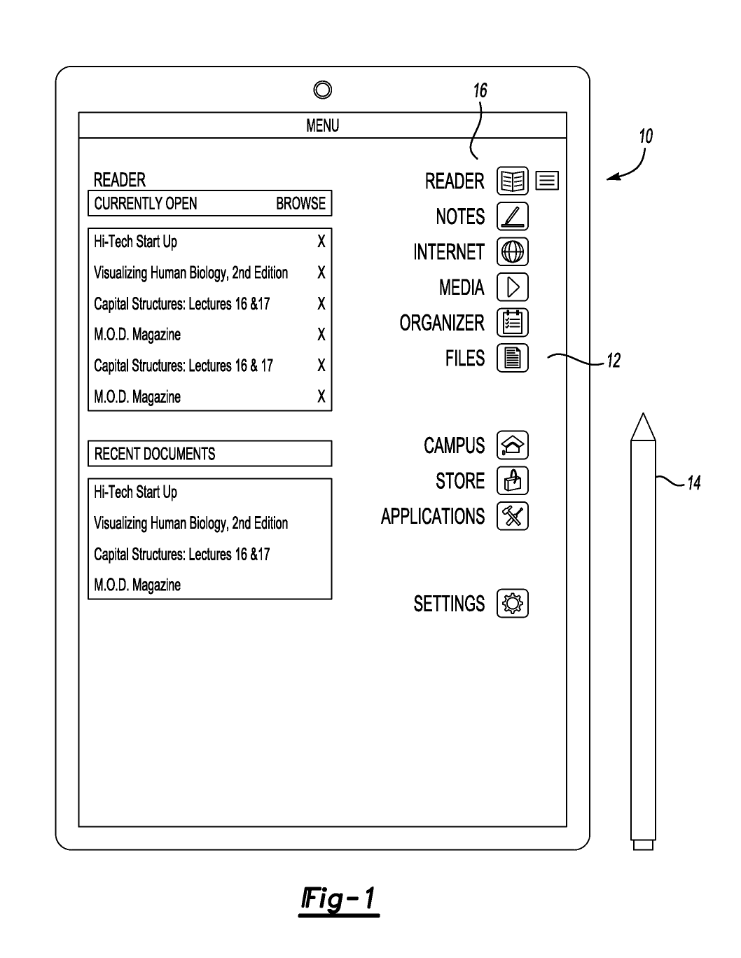

The touchscreen device 10 of FIG. 1 may be a 8½×11 inch touch-screen device which intelligently integrates university and college student resources including textbooks, notes, Powerpoint® slides and online academic resources [ie: WebCT®, etc] into one seamless environment,

Designed as an alternative to lugging book-bags and laptops around campus; the touchscreen device 10 includes a suite of applications tailored to enhance the way students read textbooks, take-notes, manage schedules and interact with campus resources.

Core to the touchscreen device's 10 functionality is a unique digital textbook reader which allows students to highlight, type-on and ‘grab’ content directly out of their textbooks. Unlike single-dimension readers which exist today, the reader utilizes a proprietary format which overlays a new dimension of interactivity to any published content. Through the format, published data, which includes a combination of text and images, will become digitally tangible to its users in a form that allows for a far more intelligent utility of current publications.

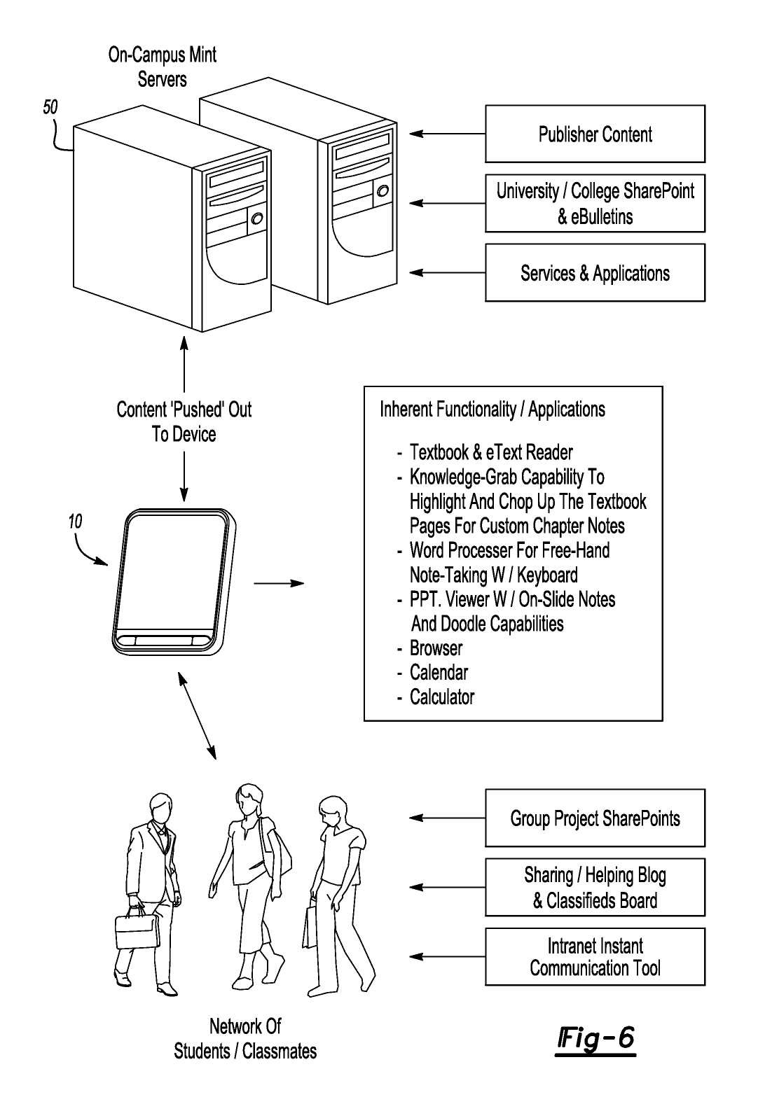

Referring to FIG. 6, the touchscreen device 10 and associated software is integrated with the existing university infrastructure via the gateway. Course materials and campus resources are accessible and pushed out to students directly on their touchscreen device 10 via Wi-Fi connection to on-campus servers 50. Communication between each student's touchscreen device 10 and these servers 50 operates effectively utilizing Student-ID authentication to grant each student access to resources relevant to their university/college life. For example, the calendar application will retrieve and populate each student's specific class schedules, assignments and exam dates directly onto their touchscreen device 10, As a connected environment, any event changes can simply be made directly online by the Course Administrators or Professors and updated-live across the appropriate class of students the next time they turn their touchscreen device 10 on.

Publications including textbooks, research papers, class notes and other content can be downloaded to the touchscreen device 10 via this connectivity and stored directly onto the devices 10 for off-line access and updated as appropriate when connected. The touchscreen device 10 is also equipped with three default accessories including 1) a slim QWERTY keyboard which connects via USB 2) a slim-shell carry case for easy mobility and protection of the touchscreen device 10 as well as 3) a standard micro USB-based power adapter for charging and static power.

The touchscreen device 10 includes a display 12 (preferably touchscreen), optional stylus 14, and menu 16 on the display 12, The example touchscreen device 10 includes provisions for both software and hardware elements—each of which are outlined in detail through this document. Other hardware and operating systems could be utilized.

### APPLICATION OVERVIEW

The Media Reader is an intricate application on the touchscreen device 10 which allows users to grab, re-purpose and interact with published content in a way that enhances their utility with what were traditionally two-dimensional publications.

Specifically, the Reader allows for three unique functions; ‘grab’, ‘drill down’ and ‘write-on’.

The grab function allows users to highlight and drag text and images from a publication into a free-hand notes sheet while maintaining a traceable pedigree to their origin-author(s) using a proprietary solution. Designed with students in mind, the grab function allows for the creation of freehand custom summary sheets without compromising the copyright parameters of the original publication.

Grabbed content will be treated as a free-hand object for easy dragging and dropping into a blank notes page. Utilizing the highlighter function, users can simply highlight for later viewing or actually grab highlighted content for their own note creation. Inherent to the Reader application is the sister app—Notes which easily allows users to create their own cheat sheets, or summary notes using ‘grabbed’ content from publications similar to the traditional scrapbook approach. These clippings of content are capable of being manipulated in their size, colour, and orientation [horiz./vert.].

Obviously, this type of functionality begs strong questions from a Digital Rights Management perspective and as such requires a form of control-gate for all ‘grabbing’ activity. The Reader offers exactly this type of unique control-measure to put the control in the hands of the publishers where appropriate. Namely, textbook publishers can set parameters or copy thresholds which limit [or liberate] readers from grabbing their content. The default control-gate is set for 28% across all content meaning students and readers will not have the ability to ‘grab’ more than 28% of any given publication or article. This control is enforced per page rather than per publication to ensure students and readers are not easily able to mash, say four sets of grabbed content, to reproduce an entire publication.

All grabbing occurs via dragging highlighted text or selected objects into a hotspot on the screen which then drops that content as a free-hand object in the designated. Notes page. Therefore the control-gate for the DRI protocol occurs at the border of this hot-spot. Information passing through the Reader to the Notes creation app is checked against a copy-log attached to each respective publication. The algorithm used is actually quite simple; each publication has a count of Total Characters+Total Objects' [objects are pictures, graphs or other non-textual content] embedded in each page within the pages tag, grabbed content from that page is cross-checked against a log of all copied content from that specific page and measured against the copythreshold [as a %] enforced by the publisher. Publishers can grant access to more or less of any given book or article to ensure flexible DRM.

Further to this, grabbed content is attached to a ‘citable tag’ which allows users to view the original source of any grabbed content and even trigger automatic footnoting to assist with referencing. Citable tags are not visible by default but easily accessible as a property of any grabbed content, The creation of these tags occurs at the border of the ‘hot-spot’ across the web browser and Reader. Though this function definitely offers an easier way to footnote essays and reports, its primary function is to protect all grabbed content from being misrepresented or unlawfully repurposed without a traceable lineage to the original source.

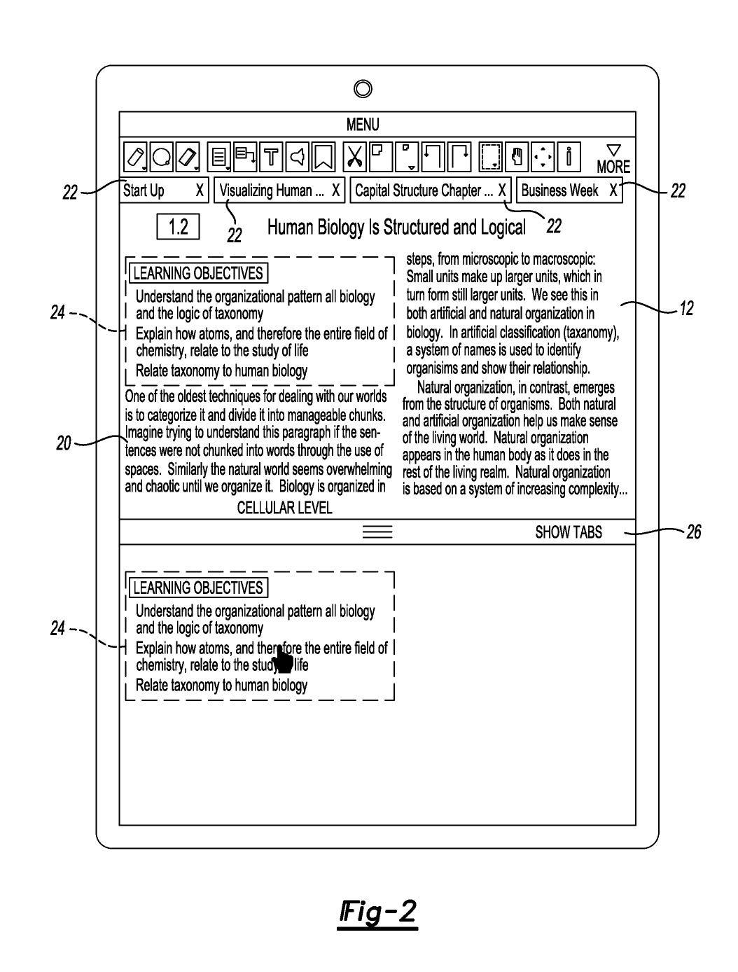

FIG. 2 shows one sample screen that could be displayed on display after choosing the ‘reader’ menu option from FIG. 1. The reader page 20 is shown at the top of the display 12, which would normally be fullscreen until the user activates a ‘notes’ page which then occupies the bottom half of the screen (other arrangements could be used). Tabs 22 at the top of the reader page 20 allow the user to switch between currently open books, while the notes page 26 stays open. The user can grab and drag a copy of a clip 24 from the reader page 20 to the notes page 26 as shown,

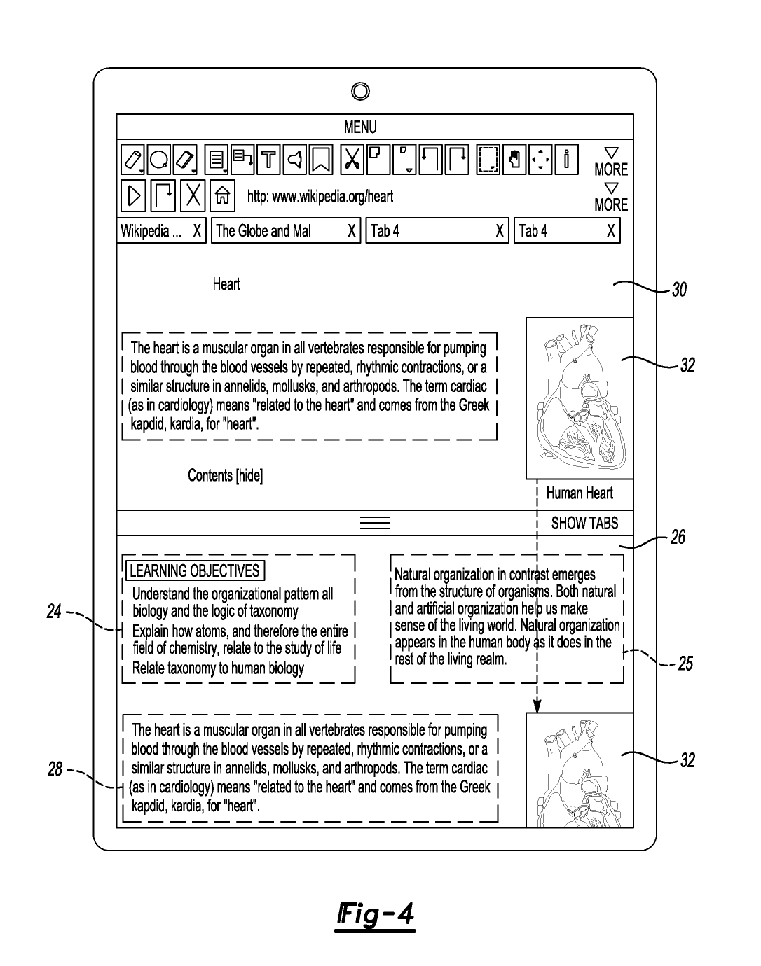

The user can switch to the web browser page 30, again while keeping the notes page 26 open. Additional clips 28 can be grabbed and dragged to the notes page 26, The clips 25, 26, 28 remain on the notes page 26 even as the user switches or closes books, web pages, etc. As shown in FIG. 4, the user can switch web pages and grab new clips 32 (this time, a picture) to drag to the notes page 26.

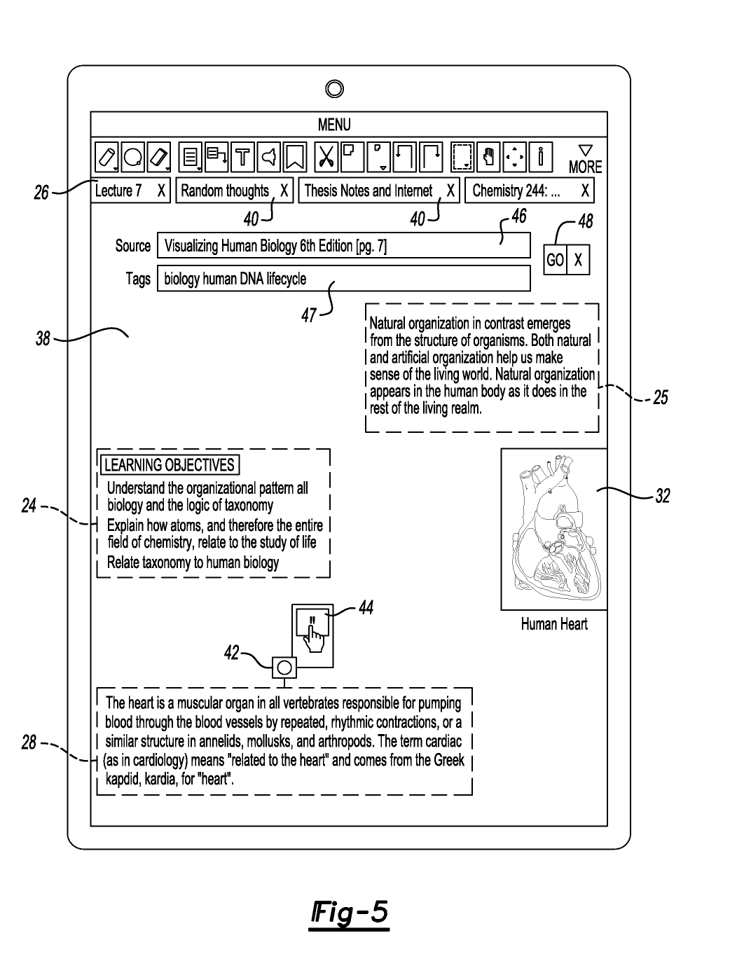

FIG. 5 shows the notes page 26 (such as may be selected from the menu 16 on FIG. 1). On the notes page 26, the user has all of the assembled clips 24, 25, 28, 32 from the various books, web pages, etc, for studying, composing, etc. Additionally, by clicking on a popup menu 42 and quote icon 44, a source field 46 and a tag field 47 appear on the notes page 26. The source field 46 indicates the original source of the selected clip 28 and clicking on the “go” button 48 opens the original source at the proper location, whether it is a book, web page, etc. The tag field 47 is a user-filled field where the user can insert his own tags to assist in organizing and finding relevant clips,

Separately, the Reader application comes with a powerful drill down function. Drill down utilizes an overlay of context-anchors and reference-tags embedded across text and image characters that allow users to interact with 2-dimensional text in a richer way and ‘read between the lines’. Users will have the ability to wiki, dictionary or link to a host of references that are locally relevant—to the pub as well as externally—via interact connectivity. For example, a reader may want to dig deeper into the word ‘retina’ while reading a biology textbook—the drill down function would allow them to view two internal links 1) the textbook definition via the glossary 2) related chapters and pages within the textbook as well as two external links 1) the Wikipedia definition and 2) the Google search results of the telID. A function which may follow the aforementioned links is a supplementary link directly to the Store which would allow users to shop for books, newspaper or magazine articles that are relevant the highlighted word.

Of course, depending on the connectivity of the touchscreen device 10 at the time of reading, the user may not have access to the external links like Wikipedia and Google.

Although variations of the drill down functionality are available across most interact browsers, the above described tool is designed for use in the Reader and Notes applications exclusively and will not be extended to the internet browser [will rely on existing browsers for this ie: Firefox, IE, Chrome, etc].

Finally, the write-on functionality allows users to write or highlight directly on any published content using a custom pen highlighter tool. Often times, readers scribble notes along the margins of their books to annotate or elaborate on published content the Reader allows for exactly this. Using a customizable pen or highlighter [customizable in colour and thickness] readers can add their own notes or highlights directly to the pages of their books in a natural and impermanent way. At the readers discretion these marks can be wiped cleanly to bring the book back to its original untouched form.

Upon immediate release, the ‘write-on’ feature may be treated as an image layer, however, the patent should provision a text-recognition capability to turn these scribbles into digital text in the near future.

It is important to note the Media Reader application is designed for use on a proprietary touch-screen interface, allowing for natural gesture-based triggers and recognition that mimics a pen-to-paper [or highlighter-to-paper] dynamic. The above described functions are triggered utilizing a pen-to-screen and finger-to-screen dynamic that is both intuitive and convenient.

Finally, the Reader will accept the following formats for viewing; e-book, Amazon e-books, and Adobe PDFs.

### NOTES APPLICATION OVERVIEW

The Notes application serves two purposes; 1) to compliment the Reader as blank slate for all grabbed content as well as 2) a standard word processing application for essay writing and document creation as well as for in-class note taking.

When used in conjunction with the Reader, the Notes app automatically starts a new blank page or opens an already active notes page each time content is grabbed and dragged into the Reader app's hot spot. Users can easily open several Notes windows for multiple document creation. The freehand format of the Notes app treats all grabbed content as an object allowing for shrinking, enlarging, rotating [horizontal, and vertical] and re-locating flexibly across their page for truly custom note creation.

To illustrate this functionality; picture two windows open, one Reader window for viewing the actual publication and one Notes window to create, for example, a chapter summary sheet. The user can peruse through the publication until they decide a. line, paragraph or image is worth grabbing for their notes. Within the Reader, the user would highlight and drag the selected content into the hot spot of the Reader window. The Notes window would immediately come to the forefront of the screen with the selected content ready for placing. The user could then decide to place it at the far right side of the page and rotate it sideways and enlarge it for emphasis on the fly with shortcut access back to the publication.

Users will always have the ability to click and trace back to the sources of their grabbed content for easy navigation.

For all word-processing or note-taking purposes, the Notes application will allow for two modes; Free-form and Notes Pro.

Free form will allow for floating text or image objects to ensure users are able to really customize their notes. The cursor can be placed anywhere on the screen to begin typing and items can be moved across the page in a truly free-form way. Written sentences and images created in the Free-form mode will each be treated as objects.

On the other hand, Notes Pro mode snaps all writing to linear grids similar to Microsoft Word® and most other word processers. This mode will be conducive to essay writing and formal documents which must fit traditionally structured document creation form.

Upon opening a new document, the user will be prompted to select one of the two above modes.

Unfortunately, once selected, the user cannot simply switch between modes,

Outside of the above mentioned capabilities, the Notes application will be a relatively normal word processing software offering the amenities and tools that come standard across other popular word processors.

### GATEWAY OVERVIEW

The touchscreen device 10 is designed for use in a connected environment. Campus and study related content, messages, and events will be pushed out through the local campus Wi-Fi network. Of course, this also allows for connectivity to the Internet for standard browsing capabilities. Each device will be assigned a unique identification key to ensure students are receiving course information and University announcements relevant to them. In fact all content pushed onto their device will be based on their respective Student ID—or BaSI. This, in tandem with a password, will act as the unified authentication protocol for access to all services, downloads and campus resources.

The deployment of this gateway will require integration with existing on-campus servers to organize student IDs and content; including bookstore products, campus resources, course calendars and schedules. To facilitate this integration, IT Administration and Faculty/Staff will have access to a Portal for uploading course-specific content and schedules that the university would like to make available for students directly on their touchscreen device 10.

For example, a Professor may upload his/her course schedule with reading assignments projects and exam deadlines through the Portal at the beginning of the year. Then, BaSI, students with touchscreen device 10s may simply download this schedule [along with their other course schedules from other profs] into their Calendar for viewing throughout the semester. The upside, of course, is the Professor's ability to simply update this schedule real-time at any given time with confidence her students will receive the update the next time they turn on their device.

The success of this integration and gateway deployment will drive an open channel for communication and organization of all campus-related events between the students and their administration.

### SPECIFICATIONS

The example touchscreen device 10 is a slate tablet handheld device, measuring 9.5″×12″×OS′, and weighing 1.5 lbs. it features a 13.86-inch dual mode display (resistive touch & pen input). The system configuration includes:

Operating System O/S (based on Linux), CPU Intel Atom 1 GHz, Graphics Nvidia ION, System Memory 1 GB DDR2 @533 MHz, System Storage 40 GB SSD, input Touch display, Digital stylus, Wireless WiFi 802.11 a/b/g, Bluetooth 2.0, Ports 2×USB 2.00, Headphone/line-out (3.5 mm), Battery Lithium Polymer, 7-10 hI's, Other Volume control wheel, Microphone, 2× Audio speakers

The operating system, a proprietary system based on Linux, features the following application suite:

Reader Viewing/reading application that supports the following formats:

ePUB, eREADER, PDF, DOC, PPT, XLS, TEXT, RTF, HTML, JPEG, PNG, GIF, and BMP. Notes Note-taking application that supports:

handwriting, highlighting, eraser, shapes, sticky notes, call-outs, text boxes, audio notes, dictionary/thesaurus, and bookmarks. The key feature is the ability to grab content from different sources.

Internet Full-feature browser, with Flash support.

Media Multimedia player that supports videos, music, and images.

Organizer Calendar, tasks/to-do's, and contacts

Files File browser

Campus Integrated with campus systems, includes support for student services, news/events, library and more.

Store On-device store where users can purchase: eBooks, eTexbooks,

eMagazines, eJournals, eNewspapers, blogs, and 3rd party applications

Applications 3rd party applications

Settings User and system settings

Other hardware could be used instead of the example device 10, such as other tablet or touchscreen devices, handheld devices, etc.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. An electronic device for reviewing media including:
a display, the display displaying a user interface that permits a user to copy clips of displayed media from multiple sources to a notes page.

2. The electronic device of claim I wherein the electronic device is a touchscreen device and wherein the display is a touchscreen display.

3. The electronic device of claim 2 further including a stylus for interacting with the touchscreen display.

4. The electronic device of claim I wherein the user can copy clips from a plurality of books to the notes page.

5. The electronic device of claim 4 wherein the clips retain their original formatting on the notes page.

6. The electronic device of claim I wherein the clips each include an original source annotation including a reference to the original source from which the clip was copied.

7. The electronic device of claim 6 further including a source field that displays the original source as requested by the user.

8. The electronic device of claim 7 wherein the clips each include a tag field containing use annotations of the clip.

9. The electronic device of claim 7 wherein the to field is selectively displayable by the user.

10. The electronic device of claim I wherein the user can copy clips from a plurality of webpages to the notes page.

11. The electronic device of claim 10 wherein the user can copy clips from a plurality of books to the notes page.

12. A method for taking notes from electronic sources including the steps of:
displaying a source on an electronic display; and
copying a clip from the source onto a notes page.

13. The method of claim 12 wherein the clip includes an annotation indicating the source of the clip.

14. The method of claim 13 wherein the dips retain their original formatting on the notes page.

15. The method of claim 12 further including the step of displaying the original source of the clip as associated with the clip upon request by the user.

16. The method of claim 12 further including the step of annotating the clip by entering text in a tag field associated with the clip.

17. The method of claim 12 further including the step of copying clips from a plurality of webpages to the notes page.

18. The method of claim 17 further including the step of copying clips from a plurality of books to the notes page.
